(19) United States
(12) Patent Application Publication
(10) Pub. No.: US 2006/0006841 A1
(43) Pub. Date: Jan. 12, 2006

(54) Battery pack and electronic device using the same

(75) Inventor: Byung-lae Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/178,397

(22) Filed: Jul. 12, 2005

(30) Foreign Application Priority Data
Jul. 12, 2004 (KR) 2004-0054164

(51) Int. Cl. H02J 7/00

(52) U.S. Cl. 320/116

(57) ABSTRACT

A battery pack and an electronic device using the same to output a plurality of power having a different voltage level each other. The battery pack includes: a power source including a plurality of battery cells, and outputting a plurality of battery powers of different voltage levels through combinations of the battery cells; and a plurality of power output terminals connectable to the electronic device and supplying the respective battery powers to the electronic device.

### CROSS-REFERENCE TO RELATED APPLICATION

This application claims the benefit of Korean Patent Application No. 2004-0054164, filed on Jul. 12, 2004, in the Korean Intellectual Property Office, the disclosure of which is incorporated herein by reference.

### BACKGROUND OF THE INVENTION

1. Field of the Invention

The present invention relates to a battery pack and an electronic device using the same, and more particularly, to a battery pack and an electronic device using the same to output a plurality of powers of different voltage levels.

2. Description of Related Art

As portable electronic devices such as cellular phones and portable computers have been developed, a secondary battery is being actively studied.

Examples of such a secondary battery include a nickel-cadmium battery, a lead storage battery, a nickel metal hydride (NiMH) battery, a lithium-ion battery, a lithium-polymer battery, a metal lithium battery, and an air zinc storage battery.

The secondary battery includes a battery pack together with a charging/discharging circuit. The secondary battery is charged/discharged through a terminal of the battery pack.

FIGS. 1 and 2 respectively illustrate configurations of conventional battery packs 200a and 200b. The battery pack 200a shown in FIG. 1 is an example of a smart battery including a control board 201 provided with a controller such as a microcomputer communicating with an electronic device such as a portable computer through a communication line of a system management BUS (SMBUS). The battery pack 200b shown in FIG. 2 is an example of a dummy battery without a function of communicating with the electronic device.

The battery pack 200a in the form of the smart battery in FIG. 1 is provided with a plurality of terminals for communicating with the electronic device as well as a power output terminal 202. For example, the battery pack 200a is provided with a terminal for transmitting a temperature of the battery pack 200a and an SMBUS terminal (generally, two pins).

As shown, the conventional battery packs 200a and 200b include: a plurality of battery cells (BC) to output power at a predetermined voltage level respectively; and the power output terminal 202 to supply the power from the battery cells (BCs) to the electronic device.

Here, the voltage level of the power outputted from the battery packs 200a and 200b is determined according to the voltage level of each of the respective battery cells (BC), the number of the battery cells (BC), and the types of connections (e.g., connection in series or parallel) between the battery cells (BC).

As shown in FIGS. 1 and 2, when each of the battery packs 200a and 200b includes four battery cells (BC) connected in series and the respective battery cells (BC) supply a voltage of 3.7V, each of the battery packs 200a and 200b supplies a power of 14.8V to the electronic device.

Meanwhile, the electronic device receiving power from the battery packs 200a and 200b includes: a system part (not shown); and a system power supply (not shown) to change power from the battery packs 200a and 200b to power for driving the system part.

The system part includes a plurality of electronic components to perform a main function of the electronic device. For example, if the electronic device is provided as the portable computer, the electronic components of the system part may include: a CPU; a memory such as: a random access memory (RAM); a chipset; a main board; and a graphic card.

The system power supply outputs power from the battery packs 200a and 200b after changing the power into an appropriate power (e.g., ±12V, ±5V, ±3.3V and ±1.2V) for driving the electronic components. Here, the respective electronic components use the power from the system power supply for driving themselves and/or transmitting a signal.

However, the voltage level of the power supplied from the battery packs 200a and 200b is fixed to a single value in the conventional electronic device, and the power having the single value of the voltage level is changed into power for driving the respective electronic components of the system, thereby leading to low efficiency.

For example, the voltage level of the power supplied to the electronic device from the battery packs 200a and 200b is 14.8V, and the system power supply should change the power of 14.8V into the voltage levels (e.g., ±12V, ±5V, ±3.3V, ±1.5V) for driving the respective electronic components of the system, thereby leading to large power loss while changing the power to ±3.3V and ±1.5V in significant difference from 14.8V.

Even though the voltage level of the power supplied from the battery packs 200a and 200b is adjusted, the battery packs 200a and 200b cannot efficiently correspond to the electronic device requiring power at various voltage levels.

### BRIEF SUMMARY

An aspect of the present invention provides a battery pack and an electronic device using the same to output a plurality of power having a different voltage level each other.

According to an aspect of the present invention, there is provided a battery pack for an electronic device, including: a power source including a plurality of battery cells, and outputting a plurality of battery powers of different voltage levels through combinations of the battery cells; and a plurality of power output terminals connectable to the electronic device and supplying the respective battery powers to the electronic device.

At least two of the battery cells may be connected in series; and output power outputted from the power source ma include power between opposite ends of the battery cells connected in series, and power from at least one of nodes between the battery cells connected in series.

At least two of the battery cells may be connected in parallel.

The battery pack may also include an output switch selectively connecting one of the two or more battery power outputted from the power source to the power output terminal; and a battery controller controlling switching of the output switch.

The battery pack may also include a control signal line for communicating with the electronic device, and the battery controller controls the output switch on the basis of a predetermined control signal received from the electronic device through the control signal line.

According to another aspect of the present invention, there is provided an electronic device including a plurality of electronic components, including: a battery pack including a plurality of power output terminals, and a power source having a plurality of battery cells and outputting a plurality of battery powers of different voltage levels by combinations of the battery cells through the plurality of power output terminals; a plurality of power input terminals connected to respective power output terminals; and a system power supply changing the plurality of battery power inputted through the respective power input terminals into power for driving the respective electronic components.

At least two of the battery cells may be connected in series, and output power outputted from the power source may include power between opposite ends of the battery cells connected in series, and power from at least one of nodes between the battery cells connected in series.

At least two of the battery cells may be connected in parallel.

The battery pack may also include an output switch selectively connecting one of two or more battery power outputted from the power source to the power output terminal; and a battery controller controlling switching of the output switch.

The electronic device may also include a system power controller outputting a control signal to make the battery controller to control the output switch; and a control signal line for transmitting the control signal from the system power controller to the battery controller.

The system power supply may include a plurality of converters receiving one of the plurality of battery power inputted through the power input terminal and converting the battery power into a voltage level of power for driving the electronic components; and an input switch selectively connecting one of two or more power input terminals to the converter according to control of the system power controller.

The battery controller may supply information about the voltage level of the battery power outputted through the power output terminal connected to two or more power input terminals selectively connected to the converter to the system power controller through the control signal line, and the system power controller may control switching of the input switch on the basis of the information received through the control signal line.

According to another aspect of the present invention, there is provided a battery pack, including: a power source including a plurality of batteries, and outputting a plurality of different voltages through different combinations of the batteries; and a plurality of power output terminals outputting the respective voltages, the plurality including a first output terminal connected to a first battery, a second output terminal connected to a second battery, and a third power output terminal connected to a node between the first and the second batteries. A connection of the first and second power output terminals outputs a voltage corresponding to a potential difference between the first and second batteries. A connection of the second and third power output terminals outputs a voltage corresponding to a potential difference between the second battery and the node.

According to another aspect of the present invention, there is provided a battery pack, including: a power source including a plurality of batteries, and outputting a plurality of different voltages through different combinations of the batteries; and a plurality of power output terminals outputting the respective voltages, the plurality including a first output terminal connected to a first pair of batteries connected in parallel, a second output terminal connected to a second pair of batteries connected in parallel, and a third power output terminal connected to a node between the first and second pairs of batteries. The first and second pairs of batteries are connected in series. A connection of the first and second power output terminals outputs a voltage corresponding to a potential difference between the first and second pairs of batteries, and a connection of the second and third power output terminals outputs a voltage corresponding to a potential difference between the second pair of batteries and the node.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIGS. 1 and 2 illustrate a configuration of a conventional battery pack;

FIG. 3 illustrates a configuration of an electronic device according to a first embodiment of the present invention;

FIGS. 4 and 5 illustrate examples of a battery pack of the electronic device of FIG. 3;

FIG. 6 illustrates a configuration of an electronic device according to a second embodiment of the present invention; and

FIG. 7 is a configuration of an electronic device according to a third embodiment of the present invention.

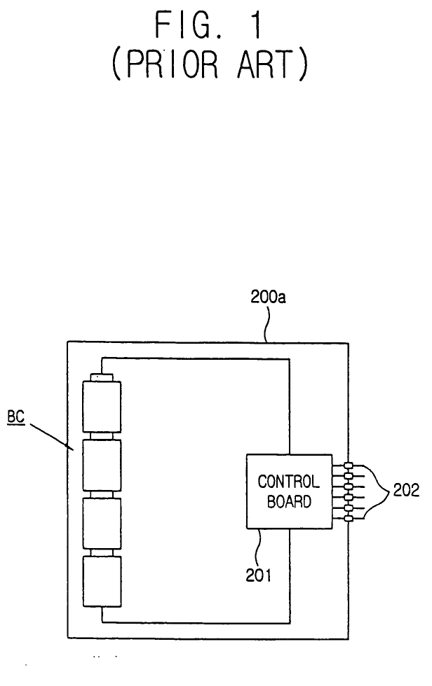

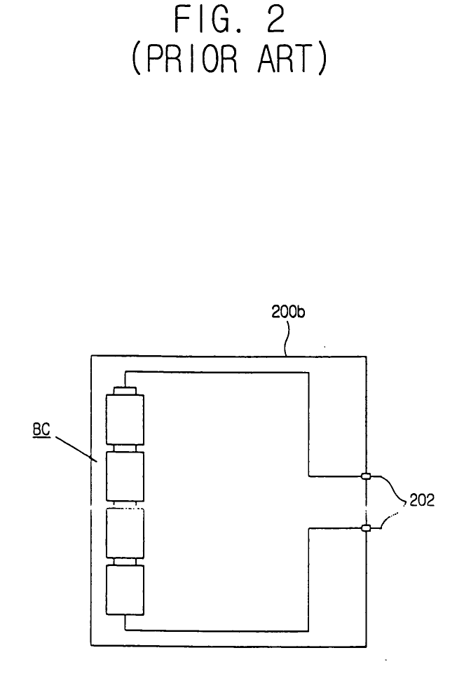

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

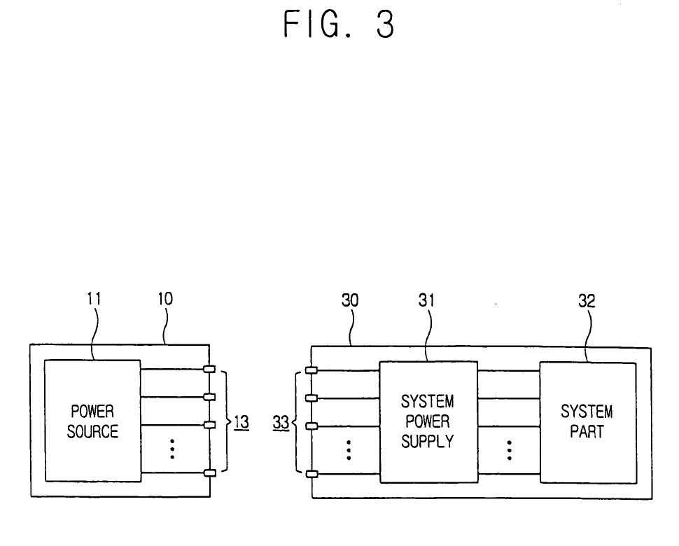

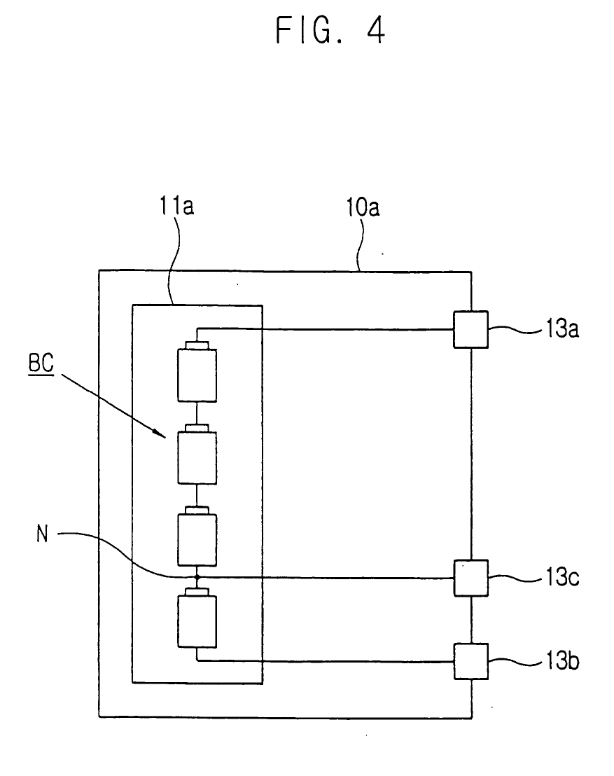

As shown in FIG. 3, an electronic device according to a first embodiment of the present invention includes: a system part 32 having a plurality of electronic components; a battery pack 10 having a power source 11 outputting a plurality of battery powers of different voltage levels; and a system power supply 31 to change the battery power supplied from the battery pack 10 into power for driving the respective electronic components of the system part 32. The power source 11 includes a plurality of battery cells (BC) (shown in FIG. 4), and outputs a plurality of battery power having a different voltage level each other through combination of the plurality of battery cells (BC).

Stated a different way, as shown in FIG. 3, the electronic device according to the first embodiment of the present invention includes the battery pack 10 and a system main body 30 provided with the system part 32 and the system power supply 31.

Also, the battery pack 10 and the system main body 30 may physically be separated. Accordingly, the battery pack 10 includes a plurality of power output terminals 13 for supplying the battery power from the power source 11 to the system main body 30. The system main body 30 includes a power input terminal 33 connected to the power output terminals 13 and supplying the battery power from the battery pack 10 to the system power supply 31 when the battery pack 10 is coupled with the system main body 30.

FIG. 4 illustrates an example of a battery pack 10a according to the first embodiment of the present invention. Referring to FIGS. 3 and 4, the battery pack 10a includes a power source 11a having four battery cells (BC) connected in series; and power output terminals 13a, 13b and 13c for supplying power from the power source 11a to the system main body 30.

The battery power outputted from the power source 11a includes power between opposite ends of the four battery cells (BC) connected in series; and power from a node (N) between the adjacent battery cells (BC). Also, the opposite ends of the four battery cells (BC) connected in series are respectively connected to the power output terminals 13a and 13b (to be referred to as “a first terminal” and “a second terminal” hereinbelow), and the node (N) between the adjacent battery cells (BC) is connected to the remaining power output terminal 13c (to be referred to as “a third terminal” hereinbelow).

The four battery cells (BC) connected in series supply a voltage of 3.7V respectively, and a potential difference between the opposite ends of the four battery cells (BC) connected in series becomes 14.8V and the power of 14.8V is outputted to the system main body 30 through the first terminal 13a and the second terminal 13b.

If the node (N) between the adjacent battery cells (BC) is provided as shown in FIG. 4, the power of 3.7V is outputted to the system main body 30 from the node (N) between the battery cells (BC) through the third terminal 13c and the second terminal 13b.

Accordingly, the battery pack 10a may supply power having voltage levels of 14.8V and 3.7V to the system main body 30.

The battery pack 10a illustrated in FIG. 4 is provided with a single node (N) between the adjacent battery cells (BC) as an example. However, it is to be understood that the battery pack 10a may be provided with one, two or more nodes between the adjacent battery cells (BC) as necessary. At this time, the power output terminals 13a, 13b and 13c and the power input terminal 33 are additionally provided according to the additional nodes (N).

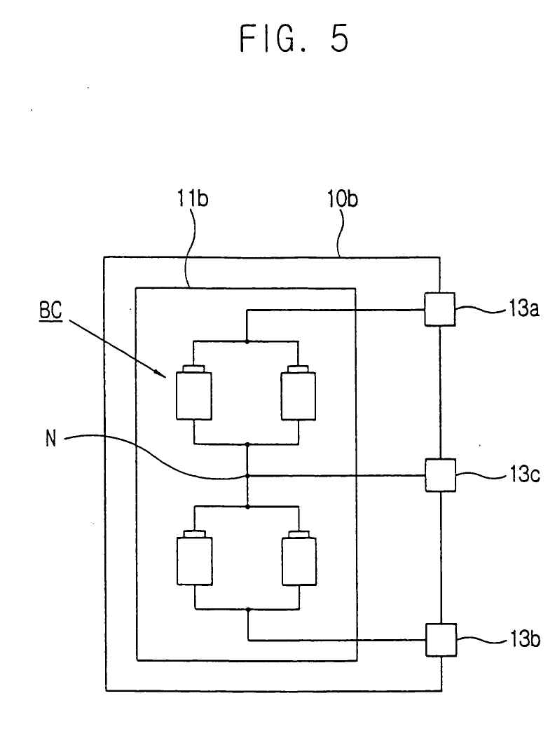

FIG. 5 illustrates another example of a battery pack 10b according to the first embodiment of the present invention. As shown therein, the battery pack 10b includes a power source 11b that pairs of the battery cells (BC) are connected in series with each pair formed parallel connection of the battery cells; and power output terminals 13a, 13b and 13c for supplying power from the power source 11b to the system main body 30.

Referring to FIGS. 4 and 5, the power outputted from the power source 11b includes power outputted from four battery cells (BC) connected in series/parallel; and power from a node (N) between the pairs of the battery cells (BC) connected in series. Also, the power outputted from the four battery cells (BC) is supplied to the system main body 30 through the first terminal 13a and the second terminal 13b. The power from the node (N) is supplied to the system main body 30 through the third terminal 13c and the second terminal 13b.

The four battery cells (BC) supply a voltage of 3.7V respectively, and a power of 7.4V is supplied to the system main body 30 through the first terminal 13a and the second terminal 13b, and a power of 3.7V is supplied to the system main body 30 through the third terminal 13c and the second terminal 13b.

Accordingly, the battery pack 10b may supply power having voltage levels of 7.4V and 3.7V to the system main body 30.

Meanwhile, power at various voltage levels outputted from the battery packs 10,10a and 10b is supplied to the system power supply 31 through the power input terminal 33 of the system main body 30. Here, the system power supply 31 changes the inputted power into power for driving the respective electronic components according to a voltage level of the inputted power.

If inputted with power of 3.7V and 14.8V from the battery pack 10a shown in FIG. 4 and the system part 32 requires power of ±12V, ±5V, ±3.3V and ±1.5V, the system power supply 31 may be provided to output a power of ±12V by using a power of 14.8V, and output power of ±5V, ±3.3V and ±1.5V by using a power of 3.7V.

Accordingly, the electronic device changes the power from the battery packs 10,10a and 10b, thereby minimizing power loss and increasing efficiency.

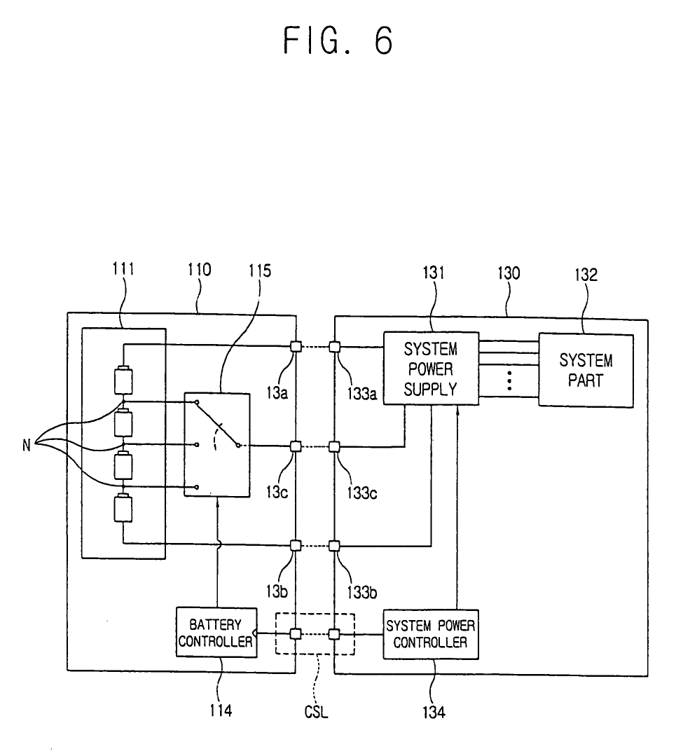

FIG. 6 illustrates an electronic device according to a second embodiment of the present invention. As shown therein, the electronic device includes: a system part 132 having a plurality of electronic components; a battery pack 110 having a power source 111 outputting a plurality of battery power having a different voltage level each other; and a system power supply 131 changing the batter power supplied from the battery pack 110 into power for driving the respective electronic components of the system part 132.

Stated a different way, the electronic device according to the second embodiment of the present invention includes: the battery pack 110; and a system main body 130 provided with the system 132 and the system power supply 131 like the electronic device according to the first embodiment of the present invention. Also, the battery pack 110 includes a plurality of power output terminals 13a, 13b and 13c, and the system main body 130 includes power input terminals 133a, 133b and 133c.

Also, the battery pack 110 according to the second embodiment of the present invention may include: an output switch 115 provided between the power source 111 and the power output terminals 13a, 13b and 13c; and a battery controller 114 to control the output switch 115.

The output switch 115 receives a plurality of battery power outputted from the power source 111. Then, the output switch 115 selects at least one battery power from the inputted battery power according to control of the battery controller 114 and supplies the battery power to the power output terminals 13a, 13b and 13c.

Referring to FIG. 6, a detailed description of the battery pack 110 according to the second embodiment of the present invention is as follows. Here, the power source 111 includes: of four battery cells (BC) connected in series as an example. Also, the power outputted from the power source 111 includes power between opposite ends of the four battery cells (BC) connected in series; and power from three nodes (N) between the adjacent battery cells (BC) as an example.

Here, the power between the opposite ends of the four battery cells (BC) is supplied to the system main body 130 through the first terminal 13a and the second terminal 13b among the power output terminals 13a, 13b and 13c. The power from the three nodes (N) between the adjacent battery cells (BC) is supplied to the output switch 115.

The output switch 115 selects one of the power from the three nodes (N) of the power source 111 according to the control of the battery controller 114, and supplies the power from the selected node (N) to the system main body 130 through the third terminal 13c and the second terminal 13b.

For example, if the four battery cells (BC) connected in series supplies a voltage of 3.7V respectively, a potential difference between the opposite ends of the four battery cells (BC) connected in series becomes 14.8V, and a power of 14.8V is supplied to the system main body 130 through the first terminal 13a and the second terminal 13b.

According to selection through the output switch 115, one of voltage levels of 3.7V, 7.4V and 11.1V is supplied to the system main body 130 through the third terminal 13c and the second terminal 13b.

Accordingly, at least a part of voltage levels of the plurality of battery power outputted from the battery pack 110 is changed, thereby appropriately corresponding to the voltage level of power for driving the respective electronic components of the electronic device.

Meanwhile, the electronic device according to the second embodiment of the present invention includes a system power controller 134 to output a control signal to make the battery controller 114 to control the output switch 115. Accordingly, at least a part of various voltage levels outputted from the battery pack 110 through the system power controller 134 provided in the system main body 130 may be selected. The battery pack 110 may be applied to various system main bodies requiring power at various voltage levels.

Here, the system power controller 134 outputs the control signal to the battery controller 114 through a control signal line (CSL) which connects the battery pack 110 and the system main body 130. If the electronic device according to the present embodiment is provided as a portable computer, the control signal line (CSL) between the system power controller 134 and the battery controller 114 may include a system management BUS (SMBUS).

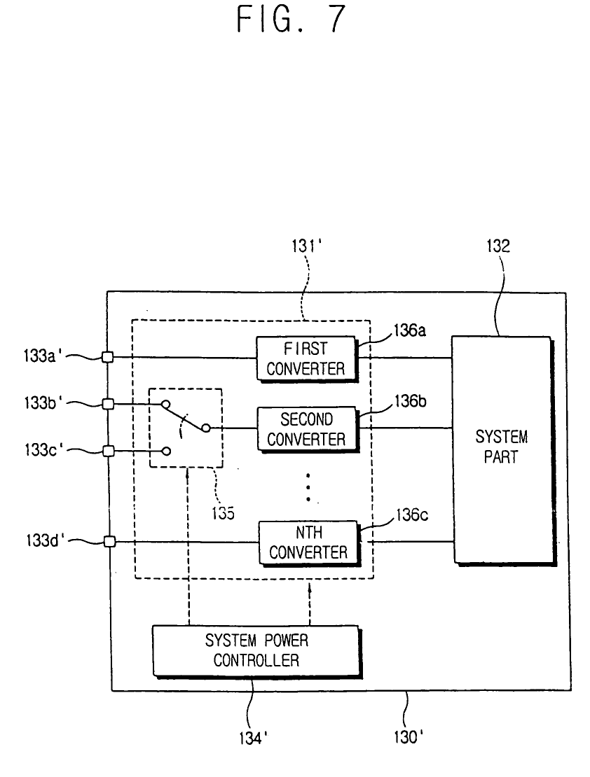

Meanwhile, FIG. 7 illustrates a configuration of an electronic device 130′ according to a third embodiment of the present invention.

As shown therein, a system power supply 131′ of the electronic device 130′ according to the third embodiment of the present invention includes a plurality of converters 136a, 136b and 136c; and an input switch 135.

The respective converters 136a, 136b and 136c convert power inputted from power input terminals 133a′, 133b′, 133c′ and 133d′ into voltage levels according to the respective specifications and supplies them to the respective electronic components of a system part 132. For example, if the electronic device 130′ according to the present embodiment is provided as a portable computer, the respective converters 136a, 136b and 136c output various voltage levels (e.g. ±5V, ±3.3V and ±2.5V) for driving the respective electronic components of the system part 132. The power of the respective voltage levels is supplied as power for driving a CPU, a memory such as: a random access memory (RAM); a chipset; a main board; a graphic card, etc. and transmitting a signal according to requirement of the respective electronic components. The converters 136a, 136b and 136c may include a switching voltage regulator. Alternatively, other voltage regulators may be used to change the voltage level of the inputted power and output it.

The input switch 135 selectively connects one of two or more of power input terminals 133b′ and 133c′ to the converter 136b. Accordingly, the voltage level of the battery power inputted to the single converter 136b may be changed. For example, if the voltage levels of the battery power inputted through the two power input terminals 133b′ and 133c′ are 15V and 5V respectively and the converter 136b of the system power supply 131′ connected with the input switch 135 outputs a power of 3V, the input switch 135 operates to make the power input terminal 133c′ inputted with a battery power of 5V and the converter 136b outputting a power of 3V to be connected with each other for power conversion efficiency and power saving of the battery. Meanwhile, if the voltage levels of the battery power inputted through the two power input terminals 133b′ and 133c′ are 15V and 5V respectively and the converter 136b of the system power supply 131′ connected with the switch outputs a power of 12V, the switch preferably operates to make the power input terminal 133b′ inputted with the battery power of 15V and the converter 136b outputting a power of 12V to be connected with each other for power conversion efficiency and power saving of the battery.

Here, the switching of the input switch 135 may be performed according to control of the system power controller 131′. At this time, the output voltage level of the converter 136b of the system power supply 131′ connected with the input switch 135 and the voltage level of the battery power inputted through the power input terminals 133b′ and 133c′ selectively connected to the corresponding converter 136b according to the switching of the input switch 135 may be preset and stored in the system power controller 131′. Also, the system power controller 131′ may receive information about the voltage level of the battery power outputted through the power output terminal (not shown) connected with the power input terminals 133b′ and 133c′ selectively connected to the corresponding converter 136b from the foregoing battery controller according to the switching of the input switch 135.

In the foregoing embodiments, the battery packs 10, 10a, 10b and 110 are described as elements of the electronic device. However, it is to be understood that each of the battery packs 10, 10a, 10b and 110 may be a device independent of the electronic device. At this time, the electronic device may include only a configuration of the foregoing system main bodies 30 and 130.

Also, the configurations of the battery packs 10a and 10b shown in FIGS. 4 and 5 are provided to describe the battery pack 10 according to an embodiment of the present invention, but not limited thereto. For example, the battery packs 10a and 10b may output a plurality of battery power having a different voltage level each other through various combinations (connection in series and/or in parallel).

In the foregoing embodiments, the battery packs 10, 10a, 10b and 110 are provided as the dummy battery as an example. However, it is to be understood that the battery pack 10 according to an embodiment of the present invention may be provided as a smart battery. At this time, the power from the power sources 11, 11a, 11b and 111 may be supplied to the power output terminal through a control board (not shown). Also, the battery controller 114 and the output switch 115 may be provided on the control board.

By providing the power sources 11, 11a, 11b and 111 having the plurality of battery cells (BC) and outputting the plurality of battery power having the different voltage level each other through the combination of the plurality of battery cells (BC), and the battery packs 10, 10a, 10b and 110 connected to the electronic device and having the plurality of power output terminals 13 supplying the respective battery power outputted from the power sources 11, 11a, 11b and 111 to the electronic device, the plurality of power having the different voltage level each other are supplied to the electronic device, and the electronic device efficiently uses the power supplied from the battery packs 10, 10a, 10b and 110.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A battery pack for an electronic device, comprising:
a power source including a plurality of battery cells, and outputting a plurality of battery powers of different voltage levels through combinations of the battery cells; and
a plurality of power output terminals connectable to the electronic device and supplying the respective battery powers to the electronic device.

2. The battery pack according to claim 1, wherein at least two of the battery cells are connected in series; and
wherein output power outputted from the power source includes power from between opposite ends of the battery cells connected in series, and power from a node between the battery cells connected in series.

3. The battery pack according to claim 2, wherein at least two of the battery cells are connected in parallel.

4. The battery pack according to claim 1, further comprising:
an output switch selectively connecting one of the two battery powers outputted from the power source to one of the power output terminals; and
a battery controller controlling switching of the output switch.

5. The battery pack according to claim 4, further comprising:
a control signal line communicating with the electronic device, and
the battery controller controlling the output switch on the basis of a control signal received from the electronic device through the control signal line.

6. An electronic device including a plurality of electronic components, comprising:
a battery pack including a plurality of power output terminals, and a power source having a plurality of battery cells and outputting a plurality of battery powers of different voltage levels by combinations of the battery cells through the plurality of power output terminals;
a plurality of power input terminals connected to respective power output terminals; and
a system power supply changing the plurality of battery power inputted through the respective power input terminals into power for driving the respective electronic components.

7. The electronic device according to claim 6, wherein at least two or more of the battery cells are connected in series, and
output power outputted from the power source includes power between opposite ends of the battery cells connected in series, and power from at least one of nodes between the battery cells connected in series.

8. The electronic device according to claim 7, wherein at least two of the battery cells are connected in parallel.

9. The electronic device according to claim 7, wherein the battery pack also includes: an output switch selectively connecting one of two or more battery power outputted from the power source to the power output terminal; and a battery controller controlling switching of the output switch.

10. The electronic device according to claim 9, further comprising:
a system power controller outputting a control signal to make the battery controller to control the output switch; and
a control signal line transmitting the control signal from the system power controller to the battery controller.

11. The electronic device according to claim 10, wherein the system power supply includes: a plurality of converters receiving one of the plurality of battery power inputted through the power input terminal and converting the battery power into a voltage level of power for driving the electronic components; and an input switch selectively connecting one of at least two power input terminals to the converter according to control of the system power controller.

12. The electronic device according to claim 11, wherein the battery controller supplies information about the voltage level of the battery power outputted through the power output terminal connected to at least two power input terminals selectively connected to the converter to the system power controller through the control signal line, and the system power controller controls switching of the input switch on the basis of the information received through the control signal line.

13. The electronic device according to claim 12, wherein the electronic device is a computer, and the control signal line includes a system management BUS (SMBUS).

14. A battery pack, comprising:
a power source including a plurality of batteries, and outputting a plurality of different voltages through different combinations of the batteries; and
a plurality of power output terminals outputting the respective voltages, the plurality including a first output terminal connected to a first battery, a second output terminal connected to a second battery, and a third power output terminal connected to a node between the first and the second batteries,
wherein a connection of the first and second power output terminals outputs a voltage corresponding to a potential difference between the first and second batteries, and
wherein a connection of the second and third power output terminals outputs a voltage corresponding to a potential difference between the second battery and the node.

15. A battery pack, comprising:
a power source including a plurality of batteries, and outputting a plurality of different voltages through different combinations of the batteries; and
a plurality of power output terminals outputting the respective voltages, the plurality including a first output terminal connected to a first pair of batteries connected in parallel, a second output terminal connected to a second pair of batteries connected in parallel, and a third power output terminal connected to a node between the first and second pairs of batteries,
wherein the first and second pairs of batteries are connected in series, and
wherein a connection of the first and second power output terminals outputs a voltage corresponding to a potential difference between the first and second pairs of batteries, and a connection of the second and third power output terminals outputs a voltage corresponding to a potential difference between the second pair of batteries and the node.
